(19) United States
(12) Patent Application Publication
(10) Pub. No.: US 2005/0284178 A1
(43) Pub. Date: Dec. 29, 2005

(54) Mold for molding glass pieces and method for making mold

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/139,737

(22) Filed: May 27, 2005

(30) Foreign Application Priority Data
Jun. 25, 2004 (CN) 200410027907.3

(51) Int. Cl. C03B 40/02

(52) U.S. Cl. 65/26; 65/374.15; 65/374.13; 65/25.1

(57) ABSTRACT

A mold (1) for molding glass pieces includes a substrate (10), and a protecting film (20) attached on a surface of the substrate. The protecting film includes at least one carbon layer (201) and at least one silicon carbide layer (202), which are stacked one on the other in turn. The carbon layer and the silicon carbide layer are alternately deposited on the substrate by sputtering or by plasma enhanced chemical vapor deposition, in either case after polishing of the surface of the substrate. In each use of the mold, the outmost carbon layer or silicon carbide layer reacts with molten glass material to form a carbon dioxide gas bearing layer. The carbon dioxide gas bearing layer enables the molding glass piece to be separated and released from the mold easily and without damage. The mold is inexpensive, has a long service lifetime, and yields fine quality molding glass pieces.

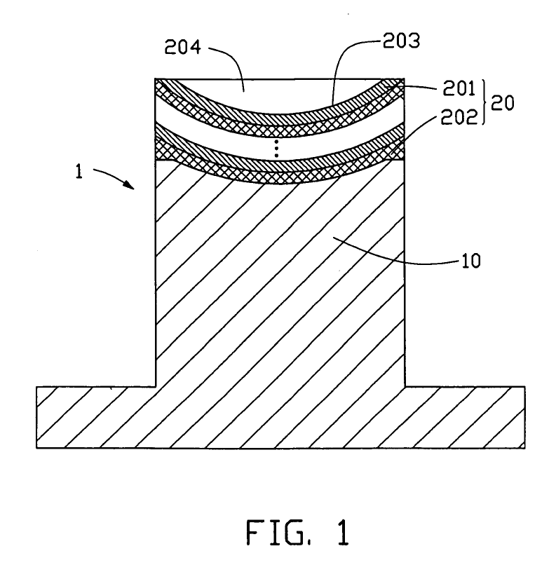

### BACKGROUND OF THE INVENTION

1. Field of the Invention

The present invention relates to a mold for molding glass pieces such as lenses, and particularly to a mold which has a multilayer overcoat. The present invention further relates to a method for making such mold.

2. Related Art

Regarding a mold used for molding glass pieces such as lenses, it is important that (1) a material of the molding surface of the mold does not react with or adhere to the glass material, (2) the molding surface is hard enough not to be damaged by scratching or the like, (3) the mold is strong and does not deform, even at very high temperatures, (4) the mold is highly resistant to heat shock, (5) the machinability of the mold is excellent so as to reduce the machining time and cost, and (6) the service lifetime of the mold is long so as to reduce costs.

A mold for molding glass pieces typically comprises a substrate and a protecting film. Further, a buffer layer is often provided between the substrate and the protecting film. The substrate can be made of any of stainless steel, silicon carbide (SiC), tungsten carbide (WC), and so on. The buffer layer can facilitate the protecting film adhering firmly to the substrate, and/or facilitate machining of the mold. The protecting film is needed for accurate molding of the glass, and for ensuring that the glass material does not stick to the mold. The protecting film can be made of any of amorphous carbon, a hard ceramic material such as silicon carbide or silicon nitride (Si₃N₄), a noble metal alloy mainly including platinum (Pt), iridium (Ir) or ruthenium (Ru), and so on.

The various protecting films having certain shortcomings. An amorphous carbon protecting film is susceptible to scratching, cracking, shock, and oxidation, and the thermal conductivity of the mold is not good. A mold with a hard ceramic material protecting film is difficult to machine. In addition, the hard ceramic material generally contains additives such as aluminum oxide (AlOₓ) and boric oxide (B₂O₃), which are apt to actively react with the glass material. This makes it difficult to release the molding glass piece from the mold. A mold with a noble metal protecting film generally cannot tolerate high temperatures. For example, the highest temperature tolerance of a Pt—Ir alloy is 520° C.-550° C. High molding temperatures are apt to result in thermal etching, after which the surface of the mold may crack rapidly. In addition, it is difficult to release the molding glass piece from the mold. Furthermore, the mold is unduly expensive.

What is needed, therefore, is a mold which is inexpensive, has a long service lifetime, provides easy releasing of the molding glass pieces, and yields fine quality molding glass pieces. What is also needed is a method for making such mold.

### SUMMARY

In preferred embodiments herein, a mold for molding glass pieces includes a substrate and a protecting film attached on a surface of the substrate. The protecting film includes at least one carbon layer and at least one silicon carbide layer, the carbon layer and the silicon carbide layer being stacked one on the other in turn. The carbon layer and the silicon carbide layer are alternately deposited on the substrate by sputtering or by plasma enhanced chemical vapor deposition, in either case after polishing of the surface of the substrate. In each use of the mold, the outmost carbon layer or silicon carbide layer reacts with molten glass material to form a carbon dioxide (CO₂) gas bearing layer. The carbon dioxide gas bearing layer enables the molding glass piece to be separated and released from the mold easily and without damage.

Other advantages and novel features will become more apparent from the following detailed description of preferred embodiments when taken in conjunction with the accompanying drawing, in which:

### BRIEF DESCRIPTION OF THE DRAWING

The drawing is an abbreviated, cross-sectional view of a mold for molding glass pieces in accordance with a preferred embodiment of the present invention.

### DETAILED DESCRIPTION OF PREFERRED EMBODIMENTS

Referring to the drawing, in a preferred embodiment of the present invention, a mold 1 for molding glass pieces comprises a substrate 10 and a protecting film 20 attached on the substrate 10. The protecting film 20 is a multilayer overcoat comprising several carbon layers 201 and several silicon carbide layers 202. The two kinds of layers 201, 202 are alternately stacked one on the other. The protecting film 20 defines a top molding surface 203, and the molding surface 203 defines a molding groove 204.

The substrate 10 is made of an extra-hard alloy, which mainly comprises tungsten carbide (WC). The surface of the substrate 10 is polished so as to carry corresponding characters to predetermined characters of the glass pieces, and then the carbon layers 201 and the silicon carbide layers 202 are alternately deposited on the substrate 10 by sputtering or by plasma enhanced chemical vapor deposition. A thickness of each carbon layer 201 is 10-100 nanometers (nm). A thickness of each silicon carbide layer 202 is 10-100 nm.

For the purposes of describing use of the mold 1 of the present embodiment, it is assumed that the number of carbon layers 201 is ‘n,’ and that the number of silicon carbide layers 202 is also ‘n.’ Further, it is assumed that the outside layer is a carbon layer 201. Accordingly, the structure of the protecting film 20 can be represented as:
C/SiC/C/SiC/ . . . (2n)
   Thus, the structure of the molded glass (SiO₂) and the mold 1 can be represented as:
SiO₂/C/SiC/C/SiC/C . . . (2n)/WC

The high temperature and high pressure of a typical molding process result in carbon of the outside carbon layer 201 being oxidized. That is, the carbon reacts with the oxygen of the silicon dioxide (SiO₂) to form a carbon dioxide (CO₂) gas bearing layer. The carbon dioxide gas bearing layer enables the molding glass piece to be separated and released from the mold 1 easily and without damage. After the mold 1 has been used in this way a number of times, the carbon of the outside carbon layer 201 is exhausted, and the adjoining silicon carbide layer 202 becomes the outside layer of the protecting film 20. Then, the structure of the molded glass (SiO₂) and the mold 1 can be represented as:
SiO₂/SiC/C/SiC/C . . . (2n−1)/WC

In further use, the high temperature and high pressure of the typical molding process result in carbon of the outside silicon carbide (SiC) layer 202 being oxidized. That is, the carbon reacts with the oxygen of the silicon dioxide (SiO₂) to form a carbon dioxide (CO₂) gas bearing layer. Simultaneously, the silicon of the silicon carbide (SiC) layer 202 reacts with the oxygen of the silicon dioxide (SiO₂) to form silicon dioxide (SiO₂) as a part of the molding glass. The carbon dioxide gas bearing layer enables the molding glass piece to be separated and released from the mold 1 easily and without damage. After the mold 1 has been used in this way a number of times, the carbon of the outside silicon carbide layer 202 is exhausted, and the adjoining carbon layer 201 becomes the outside layer of the protecting film 20.

The mold 1 can be repeatedly used in the above-described manner. A high yield of undamaged molding glass pieces can be produced, by reason of the alternating structure of the multilayer protecting film 20. Further, the mold 1 can provide a satisfactory service lifetime, according to the number and the thicknesses of the carbon layers 201 and silicon carbide layers 202 employed. Thus molding glass pieces with fine quality can be produced at a reduced cost.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A mold for molding glass pieces, comprising:
a substrate; and
a protecting film attached on the substrate;
the protecting film comprising at least one carbon layer and at least one silicon carbide layer, the carbon layer and the silicon carbide layer being stacked one on the other in turn.

2. The mold as claimed in claim 1, wherein the substrate is made of an extra-hard alloy comprising tungsten carbide.

3. The mold as claimed in claim 1, wherein the carbon layer and the silicon carbide layer are deposited on the substrate by sputtering or by plasma enhanced chemical vapor deposition.

4. The mold as claimed in claim 3, wherein a thickness of each of the carbon layer and the silicon carbide layer is in the range from 10-100 nm.

5. The mold as claimed in claim 3, wherein a surface of the substrate is polished before the protecting film is deposited thereon.

6. The mold as claimed in claim 1, wherein the protecting film defines a molding surface, and the molding surface defines a molding groove.

7. A method for making a mold for use in molding glass pieces, comprising the steps of:
(1) providing a substrate with a desired molding surface;
(2) polishing the surface of the substrate; and
(3) depositing a protecting film on the surface of the substrate,
the protecting film comprising at least one carbon layer and at least one silicon carbide layer which are stacked one on the other in turn.

8. The method as claimed in claim 7, wherein the substrate is made of an extra-hard alloy comprising tungsten carbide.

9. The method as claimed in claim 7, wherein the carbon layer and the silicon carbide layer are deposited by sputtering or plasma enhanced chemical vapor deposition.

10. The method as claimed in claim 7, wherein a thickness of each of the carbon layer and the silicon carbide layer is in the range from 10-100 nm.

11. A method for making a glass piece, comprising the steps of:
equipping a molding surface with at least one protecting layer;
forming said glass piece beside said molding surface for acquiring predetermined characters thereof from said molding surface; and
simultaneously exhausting said at least one protecting layer along with said forming step so as to separate said glass piece from said molding surface.

12. The method as claimed in claim 11, wherein at least one carbon protecting layer and at least one silicon carbide protecting layer are alternately equipped on said molding surface.

13. The method as claimed in claim 11, wherein a gas bearing layer is formed between said glass piece and said molding surface for separation in said exhausting step.
